(19) United States
(12) Patent Application Publication
(10) Pub. No.: US 2007/0261558 A1
(43) Pub. Date: Nov. 15, 2007

(54) Building ventilator response system

(75) Inventor: Nicholas Ashworth, Dublin, OH (US)

Correspondence Address: REINHART BOERNER VAN DEUREN P.C., 2215 PERRYGREEN WAY, ROCKFORD, IL, 61107, US

(73) Assignee: Ranco Incorporated of Delaware, Wilmington, DE (US)

(21) Appl. No.: 11/434,420

(22) Filed: May 15, 2006

(51) Int. Cl. B01D 46/00

(52) U.S. Cl. 96/397

(57) ABSTRACT

A response system for managing indoor air quality in a structure is provided. The response system comprises an indoor air quality appliance and a hazardous gas detector. The indoor air quality appliance is for improving indoor air quality in the structure and the hazardous gas detector is for sensing a hazardous gas. The hazardous gas detector is operably coupled to the indoor air quality appliance. The hazardous gas detector instructs the indoor air quality appliance to at least one of activate and increase a ventilation rate when the hazardous gas detector senses the hazardous gas one of at and above a predetermined level. As such, the indoor air quality is managed.

### FIELD OF THE INVENTION

The present invention relates generally to a building ventilation system, and more particularly, to a building ventilation system used to measure and improve indoor air quality.

### BACKGROUND OF THE INVENTION

Indoor air quality (IAQ) problems have soared since construction technology has succeeded in developing a more sealed and energy efficient structure (e.g., residential dwelling, office building, etc.). Pollutants such mold spores, allergens, pet dander, dust mites, tobacco smoke, and the like, which once escaped from the structure through cracks around windows and doors, are now trapped within the structure. As a result, the IAQ of the structure is often poor. In some cases, an environment within the structure is even more polluted than an environment outside the structure. Therefore, even though the tightly sealed structure may save energy and be less costly to own, the resultant poor IAQ can lead to persistent and objectionable odors, health problems such as “sick building syndrome”, and other undesirable side effects.

One option for maintaining or improving IAQ in the structure is occasionally opening one or more available windows. While this can be a viable option in some cases, this remedy only works for buildings that have windows that will open. For those buildings without windows that open such as, for example, modern glass-faced office buildings, such a solution is simply not possible. In addition, this solution generally defeats the purpose of building a tight structure in the first place.

Another available option for improving IAQ in structures without giving up the energy efficiency of such structures is to include either a heat recovery ventilator (HRV) or an energy recovery ventilator (ERV). The HRV and ERV, which are required by many modern building codes, are appliances that generally provide two benefits. First, the HRV and ERV utilize a heat-exchanging device that, when positioned between inbound and outbound air flows, conserves heat during the heating season and removes heat during the cooling season to save energy. Second, the HRV and ERV draw fresh air into the structure, clean and evenly circulate the fresh air within the structure, and expel stale and/or polluted air from the structure. Therefore, the structure is properly ventilated and the IAQ is maintained or improved. The HRV and ERV are typically configured to provide the above-noted ventilation by operating periodically or operating at a steady, measured pace.

In addition to requiring the HRV and the ERV, the modern building codes often mandate that a carbon monoxide (CO) detector be included in a new structure. For example, in the case of a residential dwelling, the typical modern building code requires the installation of at least one CO detector per level of the home. These CO detectors are equipped to provide an audible and/or visual warning to occupants of the structure should the level of CO rise to a dangerous level and/or remain at a potentially hazardous level for a certain amount of time. In other words, the CO detector is placed within the structure to monitor for, and warn of, an occurring or potentially hazardous CO event or condition.

Unfortunately, during a typical CO event, the rate at which the CO increases in an area or environment (e.g., a room) is relatively rapid. Even if a structure includes an HRV or ERV to ventilate the room, if the accumulation of CO is too fast, the HRV and the ERV are not, under normal operating conditions, able to keep up. In other words, the rate of CO build up simply outpaces the rate of ventilation. Despite the HRV and ERV continuing to function normally and as expected, the appliances are not able to exhaust the CO as fast as the level of the toxic and dangerous gas is able to increase. As a result, the HRV and ERV are unable to maintain the IAQ within safe levels and the CO level may very well continue to escalate. There is simply no intelligent link between the HRV or ERV and the CO detector. Only with this linkage in place can the HRV or ERV respond appropriately to sufficiently reduce the CO level in the home.

Thus, it would be desirable to have a response system that manages each of an air quality improvement appliance (e.g., an HRV, an ERV, and the like) and a hazardous gas detector (e.g., a CO detector, and the like) such that IAQ can be maintained under both normal and emergency conditions (e.g., a CO event). The invention provides such a response system. These and other advantages of the invention, as well as additional inventive features, will be apparent from the description of the invention provided herein.

### BRIEF SUMMARY OF THE INVENTION

In view of the above, the present invention provides a new and improved building ventilation system that overcomes one or more of the above identified and other problems existing in the art. More particularly, the present invention provides a new and improved building ventilation system that provides energy efficient IAQ under both normal and emergency situations. Still more particularly, the present invention provides a new and improved building ventilation system that communicates with a hazardous condition detector and that operates to relieve the hazardous condition.

In one embodiment of the present invention, a building ventilator response system including at least one hazardous condition detector and an HRV or ERV is provided. The operation of the HRV or ERV is controlled to improve IAQ and energy efficiency within a dwelling or structure during normal operation. The control of the HRV or ERV also receives information regarding detected hazardous conditions within the dwelling or structure. In one embodiment the system includes a carbon monoxide (CO) detector that communicates with or is included in the HRV or ERV control. Upon the detection or determination of a CO hazardous condition, the control operates the HRV or ERV to provide ventilation of the dwelling or structure. This ventilation includes the introduction of fresh outside air into the dwelling or structure, as well as exhausting the interior air to the exterior of the dwelling or structure. Once the hazardous condition has been eliminated, the HRV or ERV control would resume normal operation.

In another embodiment of the present invention, the building ventilator response system includes a smoke detector that communicates with or is included in the HRV or ERV control. Upon the detection of a smoke condition, the control operates to turn off the HRV or ERV so as to not feed a fire that may be starting.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified schematic view of an exemplary embodiment of a response system constructed in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

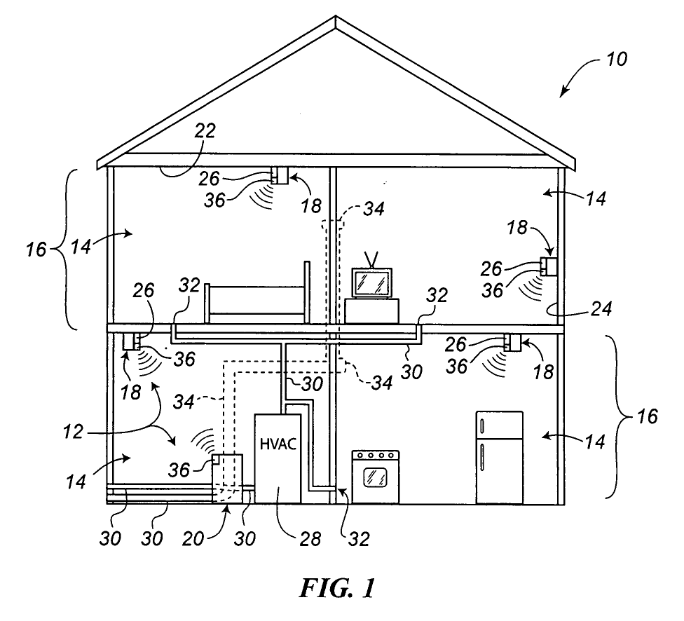

Referring to FIG. 1, a structure 10 including a building ventilator response system 12 is illustrated. The structure 10 can be a variety of different buildings such as, for example, an office building, a residential dwelling, and the like. The structure 10 often includes, among other things, a plurality of rooms 14 found on one or more floors 16. The rooms 14 can include, for example, a kitchen, a bedroom, a family room, and an office. The floors 16 can include, for example, a basement, a ground floor, and one or more sequential upper floors. The response system 12 includes at least one air quality measurement or sensing device, such as a hazardous gas detector 18, and at least one air quality improvement appliance, such as a ventilator 20.

In the illustrated embodiment of FIG. 1, several of the hazardous gas detectors 18 are shown dispersed throughout the structure 10 and secured to either a ceiling 22 or a wall 24 of the structure. Despite the depicted arrangement and securement, the hazardous gas detectors 18 can be positioned in various locations within the structure 10 and secured in a variety of places by several different methods. In one embodiment, at least one of the hazardous gas detectors 18 is found on each floor 16 of the structure 10. In an exemplary embodiment, one of the hazardous gas detectors 18 is placed in each of the rooms 14.

Each of the hazardous gas detectors 18 includes a sensor 26 able to sense a harmful, potentially harmful, toxic, noxious, poisonous, and/or explosive gas (referred to collectively as a “hazardous” gas). Examples of such hazardous gases include, but are not limited to, carbon monoxide (CO), radon, carbon dioxide, natural gas, propane, fuel vapors, solvent vapors, and the like. The hazardous gas detectors 18 are also equipped to provide an audible and/or visual waning to occupants of the structure 10 should the level of the hazardous gas reach or exceed a predetermined level. As used herein, the predetermined level can be a certain concentration of the hazardous gas and/or a certain concentration of the hazardous gas over a certain amount of time.

In one embodiment, the hazardous gas detector 18 is a CO detector having a corresponding CO sensor. The CO detector is included within the structure 10 to warn of an occurring or potentially hazardous CO event (i.e., a build up or collection of CO). In one embodiment where the hazardous gas detector 18 is a CO detector, the predetermined level of CO is one of about one hundred parts per million over ninety minutes, about two hundred parts per million over thirty-five minutes, and about four hundred parts per million over fifteen minutes. In another embodiment, the predetermined level is between about fifty parts per million and about five hundred parts per million.

The ventilator 20 of the response system 12 is disposed within the structure 10 and is operably coupled to a heating, ventilating, and air conditioning (HVAC) system 28. The ventilator 20 and the HVAC system 28 operate in conjunction with a plurality of ducts 30, registers 32, and returns 34 (optional) found in the structure 10 to cool, heat, and otherwise manage the environment within the structure. Preferably, at least one of the ducts 30 coupled to the ventilator 28 and/or the HVAC system 28 such that fresh air can be drawn from outside the structure 10 into the structure. In one embodiment, the ventilator 28, the HVAC system 28, or both are thermostatically or otherwise electronically controlled.

The ventilator 20 is preferably a heat recovery ventilator (HRV) or an energy recovery ventilator (sometimes referred to as an enthalpy recovery ventilator) (ERV). The HRV and ERV, which are now required by many modem building codes, are appliances that generally provide two benefits. First, the HRV and ERV utilize a heat-exchanging device that, when positioned proximate ducts 30 carrying inbound and outbound air flows, either conserves heat during the heating season or removes heat during the cooling season to save energy. The ERV is even able to transfer moisture due to, for example, an enthalpic core instead of an aluminum core as found in the HRV.

Second, the HRV and ERV draw fresh air from outside the structure 10 into the structure, clean and evenly circulate the fresh air within the structure, and expel stale and/or polluted air from within the structure. This circulation operation employs one or more of the ducts 30, registers 32, and returns 34. As a result of the circulation and introduction of fresh air, the structure 10 is continuously and/or continually ventilated and indoor air quality (IAQ) is maintained or improved. As well known by those skilled in the art, the HRV is usually recommended and best suited for colder climates while the ERV is usually recommended and best suited for warmer climates.

During normal, everyday operation, the HRV and ERV are configured to operate either periodically or at a steady, measured pace. When operating periodically, for example, the HRV and ERV can be repeatedly switched between on and off states, as needed, to provide the ventilation. By toggling between on and off modes, the HRV and ERV are able to provide adequate ventilation and air filtration. In contrast to operating periodically, when operating at the steady, measured pace, the HRV and ERV do not turn off. Instead, the HRV and ERV are always operating or on to clean the air in the structure in a certain or scheduled amount of time.

Whether operating periodically or at the steady, measured pace during normal, everyday operation, the HRV and ERV operate at a rate that is sufficient to adequately ventilate the structure 10. In one embodiment, the HRV and ERV can be programmed and/or configured to exhaust between about thirty-five and about sixty percent of the air within a home per hour and replace it with fresh, outdoor air. In another instance, the HRV and ERV are set to move five cubic meters of air per hundred square foot of household area. In yet another case, the rate of ventilation is maintained at not less than fifteen cubic feet per minute for each occupant of the structure 10.

The HRV and ERV are also programmed and/or configured to operate at an increased and/or expedited rate outside of normal operation and when particular circumstances dictate. The increased rate or ventilation is generally greater and/or more rapid than the rate of ventilation experienced during normal, everyday operation. The increased rate can be anywhere from just above a rate expected during normal operation up to the maximum operating rate of the HRV and ERV. When running at the increased rate of ventilation, the HRV and ERV are able to very rapidly clean and/or filter the air within the structure 10 and, if need be, introduce a substantial amount of fresh air into the structure and vent a substantial amount of stale or contaminated air from the structure.

In accordance with one embodiment of the present invention, the ventilator 20 and the one or more hazardous gas detectors 18 are operably coupled together. In one embodiment, the ventilator 20 and the hazardous gas detectors 18 are connected by, and communicate through, standard electrical wiring. In another embodiment, however, the ventilator 20 and the hazardous gas detector 18 are both equipped for wireless communication. As such, each of the ventilator 20 and the hazardous gas detector 18 include a wireless communication device 36.

The wireless communication device 36 is preferably a transmitter, a receiver, or both. In one embodiment, the wireless communication device 36 is at least one of a radio frequency transmitter and a radio frequency receiver. In such an embodiment, the radio frequency transmitter and the radio frequency receiver operate in a frequency range of about three hundred to about four hundred megahertz.

In operation, when the sensor 26 in the hazardous gas detector 18 senses that a hazardous gas has reached or exceeded the predetermined level (i.e., reached a certain concentration, been at a particular concentration for a specific period of time, etc.), the hazardous gas detector sends a command and/or instruction to the ventilator 20, preferably wirelessly, to activate if the ventilator was off and to increase the rate of ventilation if the ventilator was already operating.

When instructed to activate or operate at the increased rate in response to the elevated level of hazardous gas within the structure 10, the ventilator 20 is able rapidly clean the air within the structure 10 and/or quickly draw fresh air from outside the structure into the structure and vent or expel the contaminated air from the structure. As a result, the hazardous gas in the structure 10 is diluted or removed and further accumulation of the hazardous gas in the structure is prevented or at least inhibited. As a result, the structure 10 is adequately ventilated, the IAQ is effectively managed, and occupants of the structure are kept in good health.

After the hazardous gas is reduced to within safe levels, either by operation of the ventilator 20, by an occupant opening a door or window, or by the hazardous gas source being disabled, removed from the structure, and the like, the hazardous gas detector 18 instructs the ventilator to turn off or resume operating at the normal ventilation rate. In one embodiment, the instruction is relayed through wires and, in another embodiment, the instruction is transmitted wirelessly.

From the foregoing, those skilled in the art will recognize that the response system 12 having an air quality detection appliance in communication with an air quality improvement appliance ensures that the IAQ in the structure 10 is maintained under both normal and emergency conditions.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A response system for managing indoor air quality in a structure, the response system comprising:
an indoor air quality appliance for improving indoor air quality in the structure; and
a hazardous gas detector for sensing a hazardous gas, the hazardous gas detector operably coupled to the indoor air quality appliance and instructing the indoor air quality appliance to at least one of activate and increase a ventilation rate when the hazardous gas detector senses the hazardous gas one of at and above a predetermined level such that the indoor air quality is managed.

2. The response system of claim 1, wherein the hazardous gas detector is a carbon monoxide detector.

3. The response system of claim 1, wherein the hazardous gas is at least one of carbon monoxide and radon.

4. The response system of claim 1, wherein the indoor air quality appliance is a heat recovery ventilator.

5. The response system of claim 1, wherein the indoor air quality appliance is at least one of an energy recovery ventilator and an enthalpy recovery ventilator.

6. The response system of claim 1, wherein the ventilation rate is about five cubic meters of air per hundred square feet of structure and about fifteen cubic feet per minute for each occupant of the structure.

7. The response system of claim 1, wherein the ventilation rate is replacing about thirty-five to about sixty percent of air within the structure with fresh air every hour.

8. The response system of claim 1, wherein the indoor air quality appliance is configured to transfer moisture.

9. The response system of claim 1, wherein the predetermined level is at least one of about one hundred parts per million over ninety minutes, about two hundred parts per million over thirty-five minutes, and about four hundred parts per million over fifteen minutes.

10. The response system of claim 1, wherein the predetermined level is between about fifty parts per million and about five hundred parts per million.

11. The response system of claim 1, wherein the hazardous gas detector and the indoor air quality appliance each include a wireless communication device.

12. A response system for managing indoor air quality in a residential building, the response system comprising:
a ventilator for improving indoor air quality in the residential building, and
a hazardous gas detector for sensing a hazardous gas and operably coupled to the ventilator, the hazardous gas detector instructing the ventilator to at least one of activate and increase a ventilation rate when the hazardous gas detector senses the hazardous gas one of at and above a predetermined level such that the indoor air quality is managed.

13. The response system of claim 12, wherein the hazardous gas is one of carbon monoxide and radon.

14. The response system of claim 12, wherein the ventilator is one of a heat recovery ventilator, an energy recovery ventilator, and an enthalpy recovery ventilator.

15. The response system of claim 12, wherein the ventilation rate is one of about five cubic meters of air per hundred square feet of structure and about fifteen cubic feet per minute for each occupant of the structure.

16. The response system of claim 12, wherein the ventilation rate is about thirty-five to about sixty percent of air within the structure being replaced with fresh air every hour.

17. The response system of claim 12, wherein the predetermined level is between about fifty parts per million and about five hundred parts per million.

18. A response system for managing indoor air quality in a residential dwelling, the response system comprising:
a ventilator for improving indoor air quality in the residential dwelling; and
a carbon monoxide detector for sensing carbon monoxide and in wireless communication with the ventilator, the carbon monoxide detector wirelessly instructing the ventilator to at least one of activate and increase a ventilation rate when the carbon monoxide detector senses the carbon monoxide one of at and above the predetermined level such that the indoor air quality is managed.

19. The response system of claim 18, wherein the ventilator is one of a heat recovery ventilator, an energy recovery ventilator configured to transfer moisture, and an enthalpy recovery ventilator configured to transfer moisture.

20. The response system of claim 19, wherein the predetermined level is at least one of about one hundred parts per million over ninety minutes, about two hundred parts per million over thirty-five minutes, and about four hundred parts per million over fifteen minutes.
